(19) United States
(12) Patent Application Publication
(10) Pub. No.: US 2023/0215083 A1
(43) Pub. Date: Jul. 6, 2023

(54) VISUAL ASSET DEVELOPMENT USING A GENERATIVE ADVERSARIAL NETWORK

(71) Applicant: GOOGLE LLC, Mountain View, CA (US)

(72) Inventors: Erin Hoffman-John, Palo Alto, CA (US); Ryan Poplin, Newark, CA (US); Andeep Singh Toor, Freemont, CA (US); William Lee Dotson, San Francisco, CA (US); Trung Tuan Lee, San Francisco, CA (US)

(21) Appl. No.: 17/928,874

(22) PCT Filed: Jun. 4, 2020
(86) PCT No.: PCT/US2020/036059

§ 371 Date: Nov. 30, 2022

(51) Int. Cl. G06T 15/20; G06T 15/50; G06T 15/04

(52) U.S. Cl. CPC G06T 15/205; G06T 15/50; G06T 15/04

(57) ABSTRACT

A virtual camera captures first images of a three-dimensional (3D) digital representation of a visual asset from different perspectives and under different lighting conditions. The first images are training images that are stored in a memory. One or more processors implement a generative adversarial network (GAN) that includes a generator and a discriminator, which are implemented as different neural networks. The generator generates second images that represent variations of the visual asset concurrently with the discriminator attempting to distinguish between the first and second images. The one or more processors update a first model in the discriminator and/or a second model in the generator based on whether the discriminator successfully distinguished between the first and second images. Once trained, the generator generates images of the visual asset based on the first model, e.g., based on a label or an outline of the visual asset.

### BACKGROUND

A significant portion of the budget and resources allocated to producing a video game is consumed by the process of creating visual assets for the video game. For example, massively multiplayer online games include thousands of player avatars and non-player characters (NPCs) that are typically created using a three-dimensional (3D) template that is hand-customized during development of the game to create individualized characters. For another example, the environment or context of scenes in a video game frequently includes large numbers of virtual objects such as trees, rocks, clouds, and the like. These virtual objects are customized by hand to avoid excessive repetition or homogeneity, such as could occur when a forest includes hundreds of identical trees or repeating patterns of a group of trees. Procedural content generation has been used to generate characters and objects, but the content generation processes are difficult to control and often produce output that is visually uniform, homogenous, or repetitive. The high costs of producing the visual assets of video games drive up video game budgets, which increases risk aversion for video game producers. In addition, the cost of content generation is a significant barrier to entry for smaller studios (with correspondingly smaller budgets) attempting to enter the market for high fidelity game designs. Furthermore, video game players, particularly online players, have come to expect frequent content updates, which further exacerbates the problems associated with the high costs of producing video assets.

### SUMMARY

The proposed solution in particular relates to a computer-implemented method comprising capturing first images of a three-dimensional (3D) digital representation of a visual asset, generating, using a generator in a generative adversarial network (GAN), second images that represent variations of the visual asset and attempting to distinguish between the first and second images at a discriminator in the GAN updating at least one of a first model in the discriminator and a second model in the generator based on whether the discriminator successfully distinguished between the first and second images; and generating third images using the generator based on the updated second model. The first model is used by the generator as a basis for generating the second images, whereas the second model is used by the discriminator as a basis for evaluating the generated second images. A variation in a first image the generator generates may in particular relate to a variation in at least one image parameter of the first image, for example, a variation in at least one or all pixel or texel values of the first image. A variation by the generator may thus for example relate to a variation in at least one of a color, brightness, texture, granularity, or a combination thereof.

Machine learning has been used to generate images, e.g., using a neural network that is trained on image databases. One approach to image generation used in the present context uses a machine learning architecture known as a generative adversarial network (GAN) that learns how to create different types of images using a pair of interacting convolutional neural networks (CNNs). The first CNN (the generator) creates new images that correspond to images in a training dataset and the second CNN (the discriminator) attempts to distinguish between the generated images and the “real” images from the training dataset. In some cases, the generator produces images based on hints and/or random noise that guide the image generation process, in which case the GAN is referred to as a conditional GAN (CGAN). Generally, a “hint” in the present context may, for example, be a parameter that includes an image content characterization in a computer-readable format. Examples of hints include labels associated with the images, shape information such as the outline of an animal or object, and the like. The generator and the discriminator then compete based on the images generated by the generator. The generator “wins” if the discriminator classifies a generated image as a real image (or vice versa) and the discriminator “wins” if it correctly classifies generated and real images. The generator and the discriminator may update their respective models based on a loss function that encodes the wins and losses as a “distance” from the correct models. The generator and the discriminator continue to refine their respective models based on the results produced by the other CNN.

A generator in a trained GAN produces images that attempt to mimic the characteristics of people, animals, or objects in the training dataset. As discussed above, the generator in a trained GAN can produce the images based on a hint. For example, the trained GAN attempts to generate an image that resembles a bear in response to receiving a hint including the label “bear.” However, the images produced by the trained GAN are determined (at least in part) by the characteristics of the training data set, which may not reflect the desired characteristics of the generated images. For example, video game designers often create a visual identity for the game using a fantasy or science fiction style that is characterized by dramatic perspective, image composition, and lighting effects. In contrast, a conventional image database includes real-world photography of a variety of different people, animals, or objects taken in different environments under different lighting conditions. Furthermore, photographic face datasets are often preprocessed to include a limited number of viewpoints, rotated to ensure that faces are not tilted, and modified by applying a Gaussian blur to the background. A GAN that is trained on a conventional image database would therefore fail to generate images that maintain the visual identity created by the game designer. For example, images that mimic the people, animals, or objects in real-world photography would disrupt the visual coherence of a scene produced in a fantasy or science fiction style. Additionally, large repositories of illustrations that could otherwise be used for GAN training are subject to issues of ownership, style conflict, or simply lack the variety needed to build robust machine learning models.

The proposed solution therefore provides for a hybrid procedural pipeline for generating diverse and visually coherent content by training a generator and a discriminator of a conditional generative adversarial network (CGAN) using images captured from a three-dimensional (3D) digital representation of a visual asset. The 3D digital representation includes a model of the 3D structure of the visual asset and, in some cases, textures that are applied to surfaces of the model. For example, a 3D digital representation of a bear can be represented by a set of triangles, other polygons, or patches, which are collectively referred to as primitives, as well as textures that are applied to the primitives to incorporate visual details that have a higher resolution than the resolution of the primitives, such as fur, teeth, claws, and eyes. The training images (the “first images”) are captured using a virtual camera that captures the images from different perspectives and, in some cases, under different lighting conditions. By capturing the training images of a 3D digital representation of a visual asset an improved training dataset may be provided resulting in a diverse and visually coherent content composed of a variety of second images which may be used, separately or combined in a 3D representation of a varied visual asset, in a video game. Capturing the training images (“first images”) by a virtual camera may include capturing a set of training images relating to different perspectives or lighting conditions of the 3D representation of the virtual asset. The number of training images in the training set or the perspectives or the lighting conditions are predetermined by a user or an image capturing algorithm. For example, at least one of the number of training images in the training set, the perspectives and the lighting conditions may be preset or depend on the visual asset of which the training images are to be captured. This for example includes that capturing the training images may be performed automatically after having loaded the visual asset into an image capturing system and/or having triggered an image capturing process implementing the virtual camera.

The image capture system may also apply labels to the captured images including labels indicating the type of object (e.g., a bear), a camera location, a camera pose, lighting conditions, textures, colors, and the like. In some embodiments, the images are segmented into different portions of the visual asset such as the head, ears, neck, legs, and arms of an animal. The segmented portions of the images may be labeled to indicate the different parts of the visual asset. The labeled images may be stored in a training database.

By training the GAN, the generator and discriminator learn distributions of the parameters that represent the images in the training database produced from the 3D digital representation. i.e., the GAN is trained using the images in the training database. Initially, the discriminator is trained to identify “real” images of the 3D digital representation based on the images in the training database. The generator then begins generating (second) images, e.g., in response to a hint such as a label or a digital representation of an outline of the visual asset. The generator and the discriminator may then iteratively and concurrently update their corresponding models, e.g., based on a loss function that indicates how well the generator is generating images that represent the visual asset (e.g., how well it is “fooling” the discriminator) and how well the discriminator is distinguishing between generated images and real images from the training database. The generator models the distribution of parameters in the training images and the discriminator models the distribution of parameters inferred by the generator. Accordingly, the first model of the generator may comprise a distribution of parameters in the first images and the second model of the discriminator comprises a distribution of parameters inferred by the generator.

In some embodiments, a loss function includes a perceptual loss function that uses another neural network to extract features from the images and encode a difference between two images as a distance between the extracted features. In some embodiments, the loss function may receive classification decisions from the discriminator. The loss function may also receive information indicating the identity (or at least the true or false status) of a second image that was provided to the discriminator. The loss function may then generate a classification error based on the received information. A classification error represents how well the generator and the discriminator achieve their respective goals.

Once trained, the GAN is used to generate images that represent the visual assets based on the distribution of parameters inferred by the generator. In some embodiments, the images are generated in response to hints. For example, the trained GAN can generate an image of a bear in response to receiving a hint including a label “bear” or a representation of an outline of a bear. In some embodiments, the images are generated based on composites of segmented portions of visual assets. For example, a chimera can be generated by combining segments of images representing (as indicated by respective labels) different creatures such as the head, body, legs, and tail of the dinosaur and the wings of a bat.

In some embodiments, at least one third image may be generated at the generator in the GAN to represent a variation of the visual asset based on the first model. Generating the at least one third image may then for example comprise generating the at least one third image based on at least one of a label associated with the visual asset or a digital representation of an outline of a portion of the visual asset. Alternatively or additionally, generating the at least one third image may comprise generating the at least one third image by combining at least one segment of the visual asset with at least one segment of another visual asset.

The proposed solution further relates to a system comprising a memory configured to store first images captured from a three-dimensional (3D) digital representation of a visual asset; and at least one processor configured to implement a generative adversarial network (GAN) comprising a generator and a discriminator, the generator being configured to generate second images that represent variations of the visual asset, e.g. concurrently, with the discriminator attempting to distinguish between the first and second images, and the at least one processor being configured to update at least one of a first model in the discriminator and a second model in the generator based on whether the discriminator successfully distinguished between the first and second images

A proposed system may in particular be configured to implement an embodiment of the proposed method.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a video game processing system that implements a hybrid procedural machine language (ML) pipeline for art development according to some embodiments.

FIG. 2 is a block diagram of a cloud-based system that implements a hybrid procedural ML pipeline for art development according to some embodiments.

FIG. 3 is a block diagram of an image capture system for capturing images of a digital representation of a visual asset according to some embodiments.

FIG. 4 is a block diagram of an image of a visual asset and labeled data that represents the visual asset according to some embodiments.

FIG. 5 is a block diagram of a generative adversarial network (GAN) that is trained to generate images that are variations of a visual asset according to some embodiments.

FIG. 6 is a flow diagram of a method of training a GAN to generate variations of images of a visual asset according to some embodiments.

FIG. 7 illustrates a ground truth distribution of a parameter that characterizes images of a visual asset and evolution of a distribution of corresponding parameters generated by a generator in a GAN according to some embodiments.

FIG. 8 is a block diagram of a portion of a GAN that has been trained to generate images that are variations of a visual asset according to some embodiments.

FIG. 9 is a flow diagram of a method of generating variations of images of a visual asset according to some embodiments.

### DETAILED DESCRIPTION

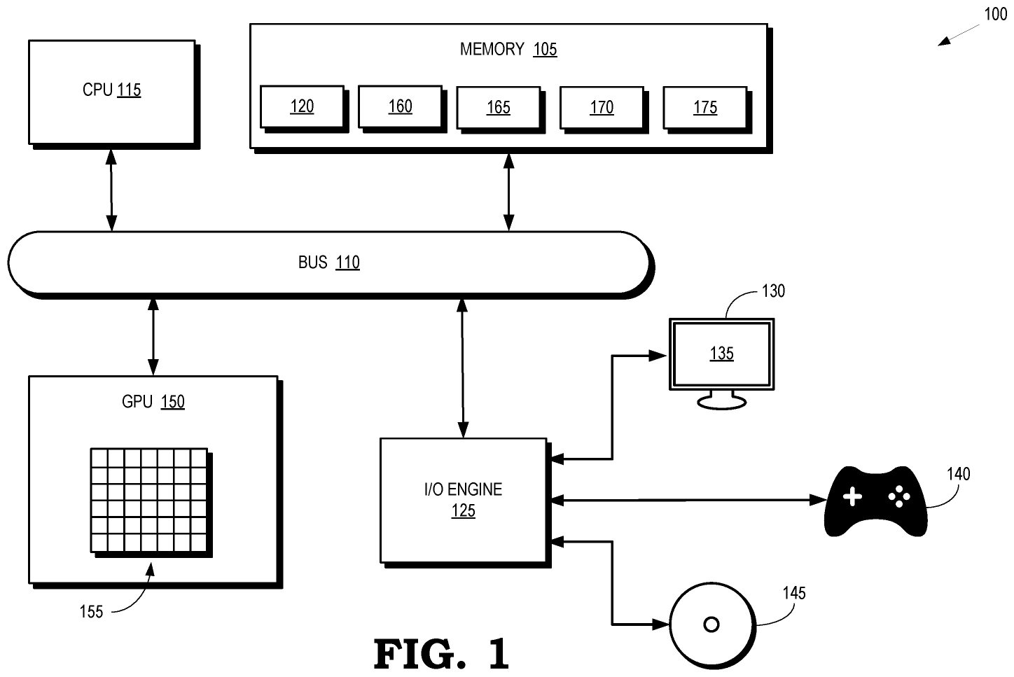

FIG. 1 is a block diagram of a video game processing system 100 that implements a hybrid procedural machine language (ML) pipeline for art development according to some embodiments. The processing system 100 includes or has access to a system memory 105 or other storage element that is implemented using a non-transitory computer readable medium such as a dynamic random-access memory (DRAM). However, some embodiments of the memory 105 are implemented using other types of memory including static RAM (SRAM), nonvolatile RAM, and the like. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The processing system 100 includes a central processing unit (CPU) 115. Some embodiments of the CPU 115 include multiple processing elements (not shown in FIG. 1 in the interest of clarity) that execute instructions concurrently or in parallel. The processing elements are referred to as processor cores, compute units, or using other terms. The CPU 115 is connected to the bus 110 and the CPU 115 communicates with the memory 105 via the bus 110. The CPU 115 executes instructions such as program code 120 stored in the memory 105 and the CPU 115 stores information in the memory 105 such as the results of the executed instructions. The CPU 115 is also able to initiate graphics processing by issuing draw calls.

An input/output (I/O) engine 125 handles input or output operations associated with a display 130 that presents images or video on a screen 135. In the illustrated embodiment, the I/O engine 125 is connected to a game controller 140 which provides control signals to the I/O engine 125 in response to a user pressing one or more buttons on the game controller 140 or interacting with the game controller 140 in other ways, e.g., using motions that are detected by an accelerometer. The I/O engine 125 also provides signals to the game controller 140 to trigger responses in the game controller 140 such as vibrations, illuminating lights, and the like. In the illustrated embodiment, the I/O engine 125 reads information stored on an external storage element 145, which is implemented using a non-transitory computer readable medium such as a compact disk (CD), a digital video disc (DVD), and the like. The I/O engine 125 also writes information to the external storage element 145, such as the results of processing by the CPU 115. Some embodiments of the I/O engine 125 are coupled to other elements of the processing system 100 such as keyboards, mice, printers, external disks, and the like. The I/O engine 125 is coupled to the bus 110 so that the I/O engine 125 communicates with the memory 105, the CPU 115, or other entities that are connected to the bus 110.

The processing system 100 includes a graphics processing unit (GPU) 150 that renders images for presentation on the screen 135 of the display 130, e.g., by controlling pixels that make up the screen 135. For example, the GPU 150 renders objects to produce values of pixels that are provided to the display 130, which uses the pixel values to display an image that represents the rendered objects. The GPU 150 includes one or more processing elements such as an array 155 of compute units that execute instructions concurrently or in parallel. Some embodiments of the GPU 150 are used for general purpose computing. In the illustrated embodiment, the GPU 150 communicates with the memory 105 (and other entities that are connected to the bus 110) over the bus 110. However, some embodiments of the GPU 150 communicate with the memory 105 over a direct connection or via other buses, bridges, switches, routers, and the like. The GPU 150 executes instructions stored in the memory 105 and the GPU 150 stores information in the memory 105 such as the results of the executed instructions. For example, the memory 105 stores instructions that represent a program code 160 that is to be executed by the GPU 150.

In the illustrated embodiment, the CPU 115 and the GPU 150 execute corresponding program code 120, 160 to implement a video game application. For example, user input received via the game controller 140 is processed by the CPU 115 to modify a state of the video game application. The CPU 115 then transmits draw calls to instruct the GPU 150 to render images representative of a state of the video game application for display on the screen 135 of the display 130. As discussed herein, the GPU 150 can also perform general-purpose computing related to the video game such as executing a physics engine or machine learning algorithm.

The CPU 115 or the GPU 150 also execute program code 165 to implement a hybrid procedural machine language (ML) pipeline for art development. The hybrid procedural ML pipeline includes a first portion that captures images 170 of a three-dimensional (3D) digital representation of a visual asset from different perspectives and, in some cases, under different lighting conditions. In some embodiments, a virtual camera captures first or training images of the 3D digital representation of a visual asset from different perspectives and/or under different lighting conditions. Images 170 may be captured by the virtual camera automatically, i.e., based on an image capturing algorithm included in program code 165. The images 170 captured by the first portion of the hybrid procedural ML pipeline, e.g., the portion including the model and the virtual camera, are stored in the memory 105. The visual asset of which the images 170 are captured can be user-generated (e.g., by using a computer assisted design tool) and stored in memory 105.

A second portion of the hybrid procedural ML pipeline includes a generative adversarial network (GAN) that is represented by program code and related data (such as model parameters) indicated by the box 175. The GAN 175 includes a generator and a discriminator, which are implemented as different neural networks. The generator generates second images that represent variations of the visual asset concurrently with the discriminator attempting to distinguish between the first and second images. Parameters that define ML models in the discriminator or the generator are updated based on whether the discriminator successfully distinguished between the first and second images. The parameters that define the model implemented in the generator determine the distribution of parameters in the training images 170. The parameters that define the model implemented in the discriminator determine the distribution of parameters inferred by the generator, e.g., based on the generator's model.

The GAN 175 is trained to produce different versions of the visual asset based on hints or random noise provided to the trained GAN 175, in which case the trained to GAN 175 can be referred to as a conditional GAN. For example, if the GAN 175 is being trained based on a set of images 170 of a digital representation of a red dragon, the generator in the GAN 175 generates images that represent variations of the red dragon (e.g., a blue dragon, a green dragon, a larger dragon, a smaller dragon, and the like). The images generated by the generator or the training images 170 are selectively provided to the discriminator (e.g., by randomly selecting between training images 170 and generated images) and the discriminator attempts to distinguish between the “real” training images 170 and the “false” images generated by the generator. The parameters of the models implemented in the generator and discriminator are then updated based on a loss function that has a value determined based on whether the discriminator successfully distinguished between the real and false images. In some embodiments, the loss function also includes a perceptual loss function that uses another neural network to extract features from the real and false images and encode a difference between two images as a distance between the extracted features.

Once trained, the generator in the GAN 175 produces variations of the training images that are used to generate images or animations for the video game. Although the processing system 100 shown in FIG. 1 performs image capture, GAN model training, and subsequent image generation using the trained model, these operations are performed using other processing systems in some embodiments. For example, a first processing system (configured in a similar manner to the processing system 100 shown in FIG. 1) can perform image capture and store the images of the visual asset in a memory that is accessible to the second processing system or transmit the images to the second processing system. The second processing system can perform model training of the GAN 175 and store the parameters that define the trained models in a memory that is accessible to a third processing system or transmit the parameters to the third processing system. The third processing system can then be used to generate images or animations for the video game using the trained models.

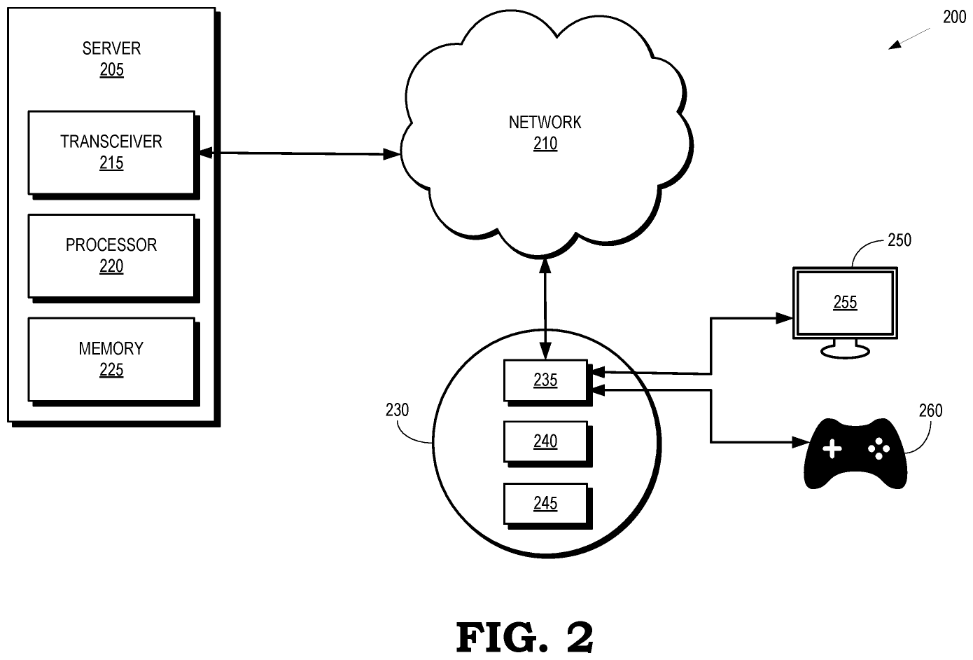

FIG. 2 is a block diagram of a cloud-based system 200 that implements hybrid procedural ML pipeline for art development according to some embodiments. The cloud-based system 200 includes a server 205 that is interconnected with a network 210. Although a single server 205 shown in FIG. 2, some embodiments of the cloud-based system 200 include more than one server connected to the network 210. In the illustrated embodiment, the server 205 includes a transceiver 215 that transmits signals towards the network 210 and receives signals from the network 210. The transceiver 215 can be implemented using one or more separate transmitters and receivers. The server 205 also includes one or more processors 220 and one or more memories 225. The processor 220 executes instructions such as program code stored in the memory 225 and the processor 220 stores information in the memory 225 such as the results of the executed instructions.

The cloud-based system 200 includes one or more processing devices 230 such as a computer, set-top box, gaming console, and the like that are connected to the server 205 via the network 210. In the illustrated embodiment, the processing device 230 includes a transceiver 235 that transmits signals towards the network 210 and receives signals from the network 210. The transceiver 235 can be implemented using one or more separate transmitters and receivers. The processing device 230 also includes one or more processors 240 and one or more memories 245. The processor 240 executes instructions such as program code stored in the memory 245 and the processor 240 stores information in the memory 245 such as the results of the executed instructions. The transceiver 235 is connected to a display 250 that displays images or video on a screen 255, a game controller 260, as well as other text or voice input devices. Some embodiments of the cloud-based system 200 are therefore used by cloud-based game streaming applications.

The processor 220, the processor 240, or a combination thereof execute program code to perform image capture, GAN model training, and subsequent image generation using the trained model. The division of work between the processor 220 in the server 205 and the processor 240 in the processing device 230 differs in different embodiments. For example, the server 205 can train the GAN using images captured by a remote video capture processing system and provide the parameters that define the models in the trained GAN to the processor 220 via the transceivers 215, 235. The processor 220 can then use the trained GAN to generate images or animations that are variations of the visual asset used to capture the training images.

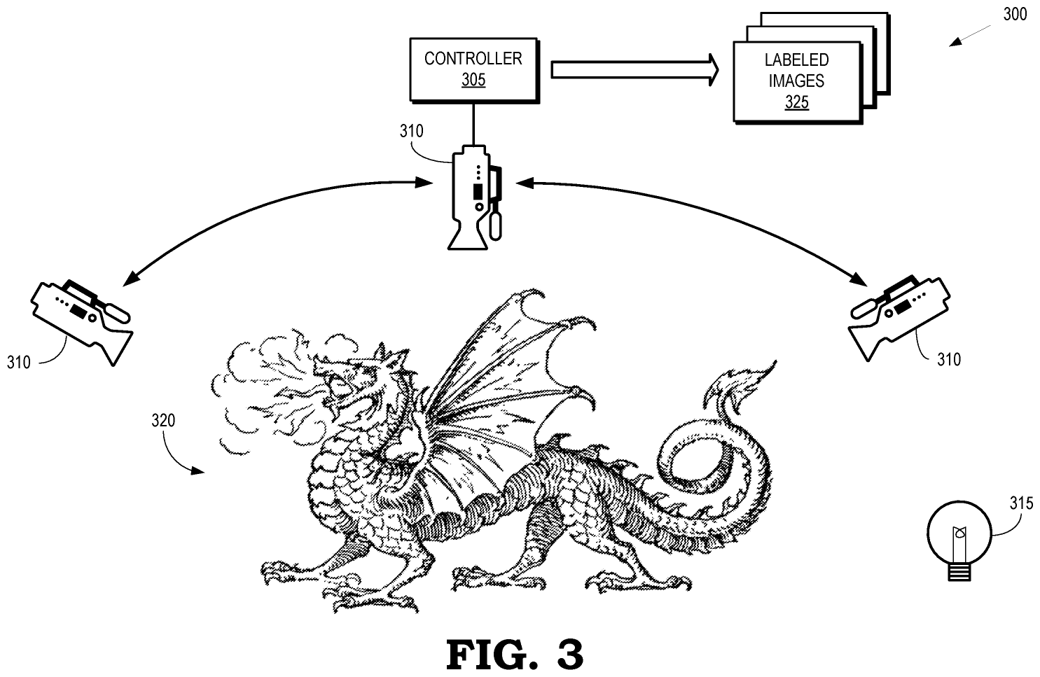

FIG. 3 is a block diagram of an image capture system 300 for capturing images of a digital representation of a visual asset according to some embodiments. The image capture system 300 is implemented using some embodiments of the processing system 100 shown in FIG. 1 and the processing system 200 shown in FIG. 2.

The image capture system 300 includes a controller 305 that is implemented using one or more processors, memories, or other circuitry. The controller 305 is connected to a virtual camera 310 and a virtual light source 315, although not all the connections are shown in FIG. 3 in the interest of clarity. The image capture system 300 is used to capture images of a visual asset 320 that is represented as a digital 3D model. In some embodiments, the 3D digital representation of the visual asset 320 (a dragon in this example) is represented by a set of triangles, other polygons, or patches, which are collectively referred to as primitives, as well as textures that are applied to the primitives to incorporate visual details that have a higher resolution than the resolution of the primitives, such as the texture and colors of the head, talons, wings, teeth, eyes, and tail of the dragon. The controller 305 selects locations, orientations, or poses of the virtual camera 310 such as the three positions of the virtual camera 310 shown in FIG. 3. The controller 305 also selects light intensities, directions, colors, and other properties of the light generated by the virtual light source 315 to illuminate the visual asset 320. Different light characteristics or properties are used in different exposures of the virtual camera 310 to generate different images of the visual asset 320. The selection of locations, orientations, or poses of the virtual camera 310 and/or the selection of light intensities, directions, colors, and other properties of the light generated by the virtual light source 315 may be based on a user selection or may be automatically determined by an image capturing algorithm executed by the image capture system 300.

The controller 305 labels the images (e.g., by generating metadata that is associated with the images) and stores them as the labeled images 325. In some embodiments, the images are labeled using metadata that indicates the type of visual asset 320 (e.g., a dragon), a location of the virtual camera 310 when the image was acquired, a pose of the virtual camera 310 when the image was acquired, lighting conditions produced by the light source 315, textures applied to the visual asset 320, colors of the visual asset 320, and the like. In some embodiments, the images are segmented into different portions of the visual asset 320 indicating different parts of the visual asset 320 which may be varied in the proposed art development process, such as the head, talons, wings, teeth, eyes, and tail of the visual asset 320. The segmented portions of the images are labeled to indicate the different parts of the visual asset 320.

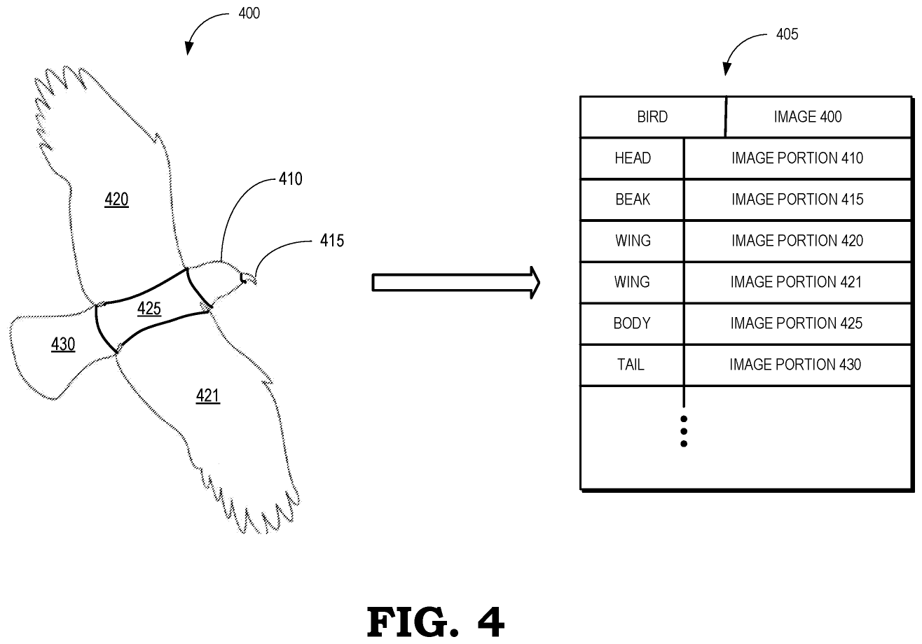

FIG. 4 is a block diagram of an image 400 of a visual asset and labeled data 405 that represents the visual asset according to some embodiments. The image 400 and the labeled data 405 are generated by some embodiments of the image capture system 300 shown in FIG. 3. In the illustrated embodiment, the image 400 is an image of a visual asset including a bird in flight. The image 400 is segmented into different portions including a head 410, a beak 415, wings 420, 421, a body 425, and a tail 430. The labeled data 405 includes the image 405 and an associated label “bird.” The labeled data 405 also includes segmented portions of the image 405 and associated labels. For example, the labeled data 405 includes the image portion 410 and the associated label “head,” the image portion 415 and the associated label “beak,” the image portion 420 and the associated label “wing,” the image portion 421 and the associated label “wing,” the image portion 425 and the associated label “body,” and the image portion 430 and the associated label “tail.”

In some embodiments, the image portions 410, 415, 420, 421, 425, 430 are used to train a GAN to create corresponding portions of other visual assets. For example, the image portion 410 is used to train a generator of the GAN to create a “head” of another visual asset. Training of the GAN using the image portion 410 is performed in conjunction with training the GAN using other image portions that correspond to a “head” of one or more other visual assets.

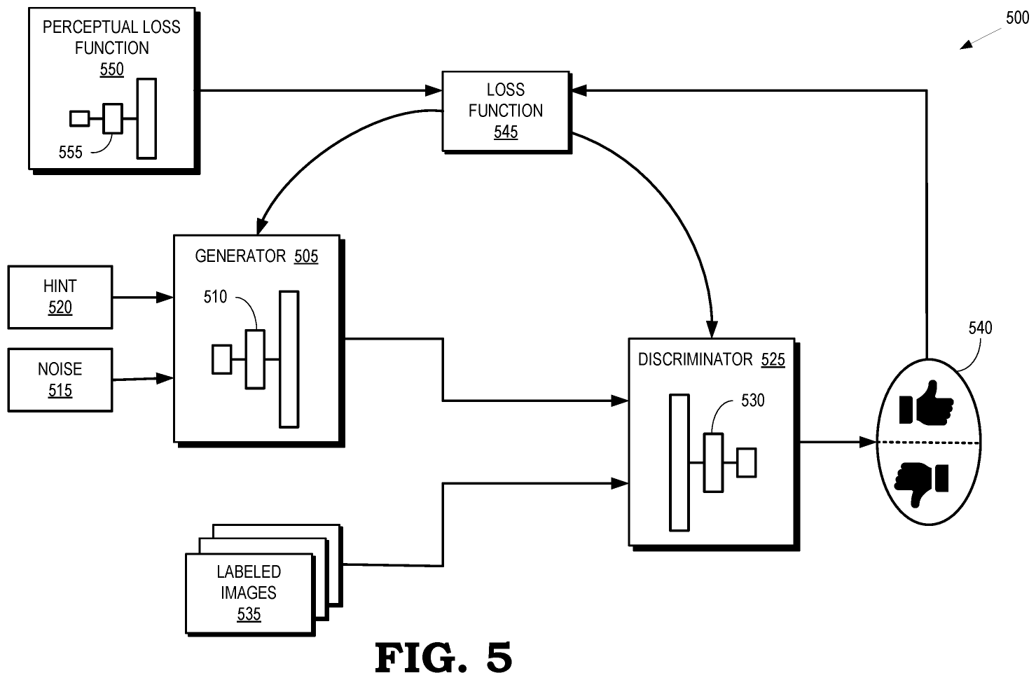

FIG. 5 is a block diagram of a GAN 500 that is trained to generate images that are variations of a visual asset according to some embodiments. The GAN 500 is implemented in some embodiments of the processing system 100 shown in FIG. 1 and the cloud-based system 200 shown in FIG. 2.

The GAN 500 includes a generator 505 that is implemented using a neural network 510 that generates images based on a model distribution of parameters. Some embodiments of the generator 505 generate the images based on input information such as random noise 515, a hint 520 in the form of a label or an outline of the visual asset, and the like. The GAN 500 also includes a discriminator 525 that is implemented using a neural network 530 that attempts to distinguish between images generated by the generator 505 and labeled images 535 of the visual asset, which represent ground truth images. The discriminator 525 therefore receives either an image generated by the generator 505 or one of the labeled images 535 and outputs a classification decision 540 indicating whether the discriminator 525 believes that the received image is a (false) image generated by the generator 505 or a (true) image from the set of labeled images 535.

A loss function 545 receives the classification decisions 540 from the discriminator 525. The loss function 545 also receives information indicating the identity (or at least the true or false status) of the corresponding image that was provided to the discriminator 525. The loss function 545 then generates a classification error based on the received information. The classification error represents how well the generator 505 and the discriminator 525 achieve their respective goals. In the illustrated embodiment, the loss function 545 also includes a perceptual loss function 550 that extracts features from the true and false images and encodes a difference between the true and false images as a distance between the extracted features. The perceptual loss function 550 is implemented using a neural network 555 that is trained based on the labeled images 535 and the images generated by the generator 505. The perceptual loss function 550 therefore contributes to the overall loss function 545.

The goal of the generator 505 is to fool the discriminator 525, i.e., cause the discriminator 525 to identify a (false) generated image as a (true) image drawn from the labeled images 535 or to identify the true image as a false image. The model parameters of the neural network 510 are therefore trained to maximize the classification error (between true and false images) represented by the loss function 545. The goal of the discriminator 525 is to distinguish correctly between the true and false images. The model parameters of the neural network 530 are therefore trained to minimize the classification error represented by the loss function 545. Training of the generator 505 and the discriminator 525 proceeds iteratively and the parameters that define their corresponding models are updated during each iteration. In some embodiments, a gradient ascent method is used to update the parameters that define the model implemented in the generator 505 so that the classification error is increased. A gradient descent method is used to update the parameters that define the model implemented in the discriminator 525 so that the classification error is decreased.

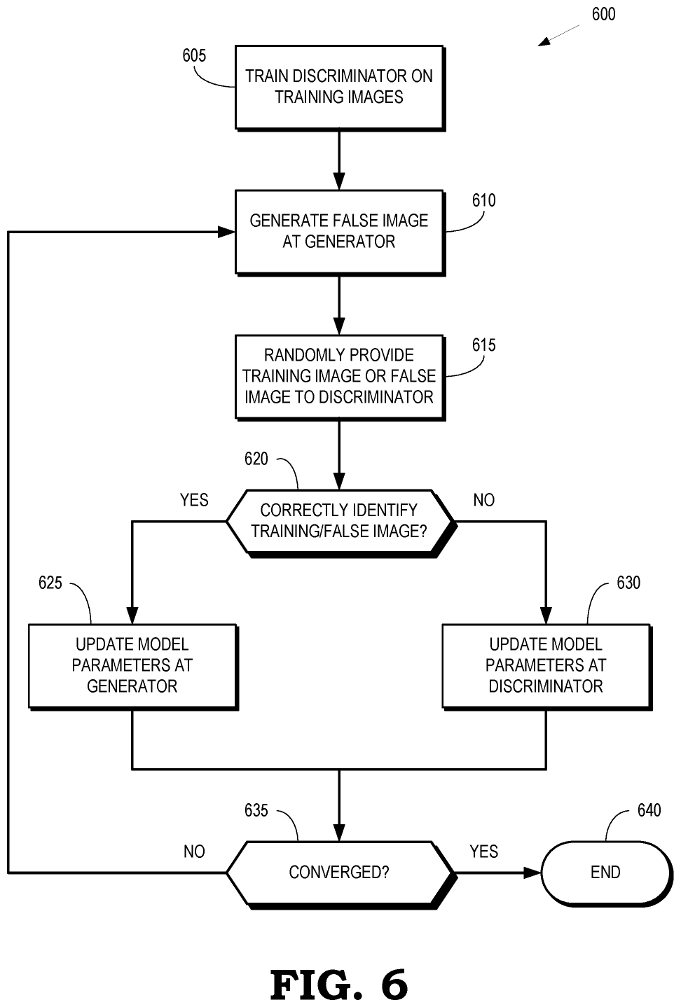

FIG. 6 is a flow diagram of a method 600 of training a GAN to generate variations of images of a visual asset according to some embodiments. The method 600 is implemented in some embodiments of the processing system 100 shown in FIG. 1, the cloud-based system 200 shown in FIG. 2, and the GAN 500 shown in FIG. 5.

At block 605, a first neural network implemented in a discriminator of the GAN is initially trained to identify images of a visual asset using a set of labeled images that are captured from the visual asset. Some embodiments of the labeled images are captured by the image capture system 300 shown in FIG. 3.

At block 610, a second neural network implemented in a generator of the GAN generates an image that represents a variation of the visual asset. In some embodiments, the image is generated based on input random noise, hint, or other information. At block 615, either the generated image or an image selected from the set of labeled images is provided to the discriminator. In some embodiments, the GAN randomly selects between the (false) generated image and the (true) labeled image that is provided to the discriminator.

At decision block 620, the discriminator attempts to distinguish between true and false images received from the generator. The discriminator makes a classification decision indicating whether the discriminator identifies the image as true or false and provides the classification decision to a loss function, which determines whether the discriminator correctly identified the image as true or false. If the classification decision from the discriminator is correct, the method 600 flows to block 625. If the classification decision from the discriminator is incorrect, the method 600 flows to the block 630.

At block 625, model parameters that define the model distribution used by the first neural network in the generator are updated to reflect the fact that the image generated by the generator did not successfully fool the discriminator. At block 630, model parameters that define the model distribution used by the second neural network and the discriminator updated to reflect the fact that the discriminator did not correctly identify whether the image received was true or false. Although the method 600 shown in FIG. 6 depicts the model parameters at the generator and the discriminator being independently updated, some embodiments of the GAN concurrently update model parameters for the generator and the discriminator based on the loss function determined in response to the discriminator providing a classification decision.

At decision block 635, the GAN determines whether the training of the generator and the discriminator has converged. Convergence is evaluated based on magnitudes of changes in the parameters of the models implemented in the first and second neural networks, fractional changes in the parameters, rates of changes in the parameters, combinations thereof, or based on other criteria. If the GAN determines that training has converged, the method 600 flows to block 640 and the method 600 ends. If the GAN determines that training is not converged, the method 600 flows to block 610 and another iteration is performed. Although each iteration of the method 600 is performed for a single (true or false) image, some embodiments of the method 600 provide multiple true and false images to the discriminator in each iteration and then update the loss function and model parameters based on the classification decisions returned by the discriminator for the multiple images.

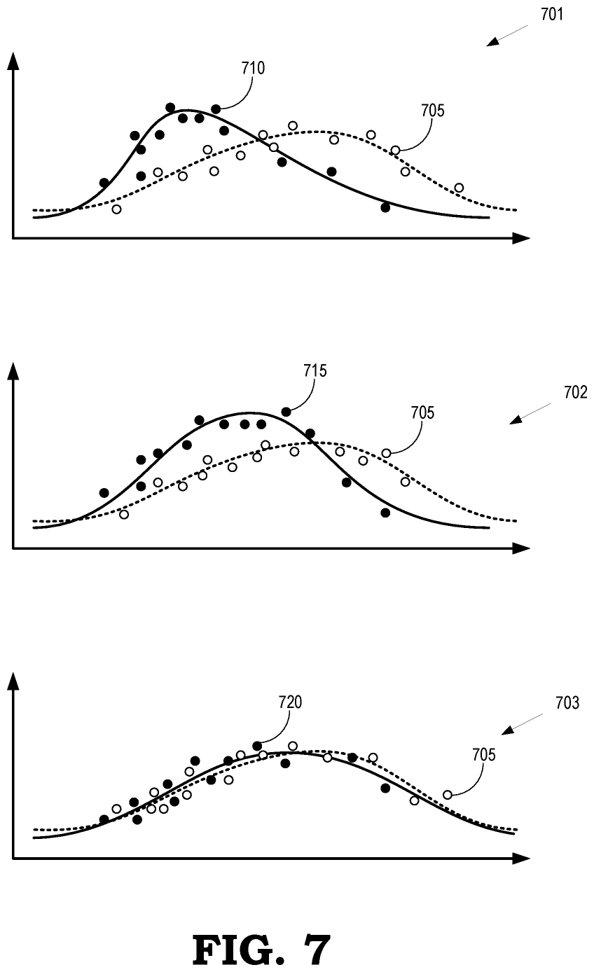

FIG. 7 illustrates a ground truth distribution of a parameter that characterizes images of a visual asset and evolution of a distribution of corresponding parameters generated by a generator in a GAN according to some embodiments. The distributions are presented at three successive time intervals 701, 702, 703, which correspond to successive iterations of training the GAN, e.g., according to the method 600 shown in FIG. 6. Values of the parameters corresponding to the labeled images captured from the visual asset (the true images) are indicated by open circles 705, only one indicated by a reference numeral in each of the time intervals 701-703 in the interest of clarity.

In the first time interval 701, values of the parameters corresponding to the images generated by the generator in the GAN (the false images) are indicated by filled circles 710, only one indicated by a reference numeral in the interest of clarity. The distribution of the parameters 710 of the false images differs noticeably from the distribution of the parameters 705 of the true images. The likelihood that the discriminator in the GAN successfully identifies the true and false images is therefore large during the first time interval 701. The neural network implemented in the generator is therefore updated to improve its ability to generate false images that fool the discriminator.

In the second time interval 702, the values of the parameters corresponding to the images generated by the generator are indicated by filled circles 715, only one indicated by reference numeral in the interest of clarity. The distribution of the parameters 715 that represent the false images is more similar to the distribution of the parameters 705 that represent the true images, indicating that the neural network in the generator is being trained successfully. However, the distribution of the parameters 715 of the false images still differs noticeably (although less so) from the distribution of the parameters 705 of the true images. The likelihood that the discriminator in the GAN successfully identifies the true and false images is therefore large during the second time interval 702. The neural network implemented in the generator is again updated to improve its ability to generate false images that for the discriminator.

In the third time interval 703, the values of the parameters corresponding to the images generated by the generator are indicated by filled circles 720, only one indicated by reference numeral in the interest of clarity. The distribution of the parameters 720 that represent the false images is now nearly indistinguishable from the distribution of the parameters 705 that represent the true images, indicating that the neural network in the generator is being trained successfully. The likelihood that the discriminator in the GAN successfully identifies the true and false images is therefore small during the third time interval 703. The neural network implemented in the generator has therefore converged on a model distribution for generating variations of the visual asset.

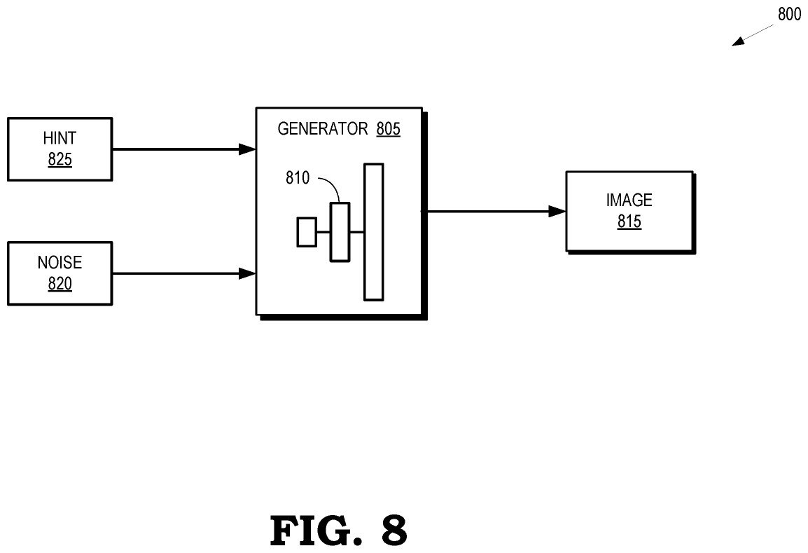

FIG. 8 is a block diagram of a portion 800 of a GAN that has been trained to generate images that are variations of a visual asset according to some embodiments. The portion 800 of the GAN is implemented in some embodiments of the processing system 100 shown in FIG. 1 and the cloud-based system 200 shown in FIG. 2. The portion 800 of the GAN includes a generator 805 that is implemented using a neural network 810 that generates images based on a model distribution of parameters. As discussed herein, the model distribution of parameters has been trained based on a set of labeled images captured from a visual asset. The trained neural network 810 is used to generate images or animations 815 that represent variations of the visual asset, e.g., for use by a video game. Some embodiments of the generator 805 generate the images based on input information such as random noise 820, a hint 825 in the form of a label or an outline of the visual asset, and the like.

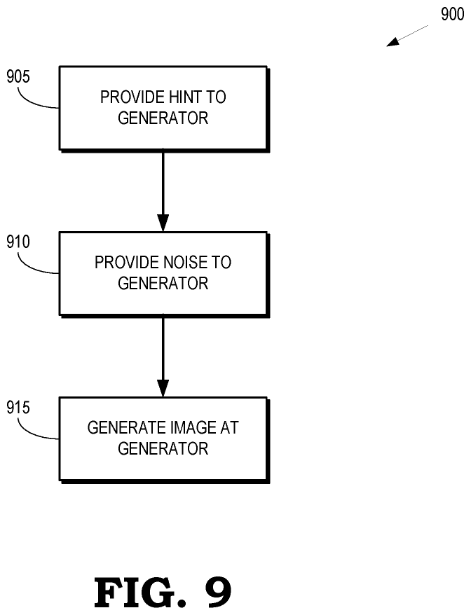

FIG. 9 is a flow diagram of a method 900 of generating variations of images of a visual asset according to some embodiments. The method 900 is implemented in some embodiments of the processing system 100 shown in FIG. 1, the cloud-based system 200 shown in FIG. 2, the GAN 500 shown in FIG. 5, and the portion 800 of the GAN shown in FIG. 8.

At block 905, a hint is provided to the generator. In some embodiments, the hint is a digital representation of a sketch of a portion (such as an outline) of the visual asset. The hint can also include labels or metadata that are used to generate the image. For example, the label can indicate a type of the visual asset, e.g., a “dragon” or a “tree”. For another example, if the visual assets are segmented, labels can indicate one or more of the segments.

At block 910, random noise is provided to the generator. The random noise can be used to add a degree of randomness to the variations of the images produced by the generator. In some embodiments, both the hint and the random noise are provided to the generator. However, in other embodiments one or the other of the hint of the random noise are provided to the generator.

At block 915, the generator generates an image that represents a variation of the visual asset based on the hint, the random noise, or a combination thereof. For example, if the label indicates a type of the visual asset, the generator generates the image of the variation of the visual asset using images having the corresponding label. For another example, if the label indicates a segment of a visual asset, the generator generates image of the variation of the visual asset based on images of the segments having the corresponding label. Numerous variations of the visual assets can therefore be created by combining different labeled images or segments. For example, a chimera can be created by combining the head of one animal with the body of another animal and the wings of a third animal.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A computer-implemented method comprising:
capturing first images of a three-dimensional (3D) digital representation of a visual asset;
generating, using a generator in a generative adversarial network (GAN), second images that represent variations of the visual asset and attempting to distinguish between the first and second images at a discriminator in the GAN;
updating at least one of a first model in the discriminator and a second model in the generator based on whether the discriminator successfully distinguished between the first and second images; and
generating third images using the generator based on the second model.

2. The method of claim 1, wherein capturing the first images from the 3D digital representation of the visual asset comprises capturing the first images using a virtual camera that captures the first images from different perspectives and under different lighting conditions.

3. The method of claim 2, wherein capturing the first images comprises labeling the first images based on at least one of a type of the visual asset, a location of the virtual camera, a pose of the virtual camera, a lighting condition, a texture applied to the visual asset, and a color of the visual asset.

4. The method of claim 3, wherein capturing the first images comprises segmenting the first images into portions associated with different portions of the visual asset and labeling the portions of the first images to indicate the different portions of the visual asset.

5. (canceled)

6. The method of claim 1, wherein updating at least one of the first model and the second model comprises applying a loss function that indicates at least one of a first likelihood that the second images are not distinguishable from the first images by the discriminator and a second likelihood that the discriminator successfully distinguishes between the first and second images.

7. The method of claim 6, wherein the first model comprises a first distribution of parameters in the first images, and wherein the second model comprises a second distribution of parameters inferred by the generator.

8. The method of claim 7, wherein applying the loss function comprises applying a perceptual loss function that extracts features from the first and second images and encodes a difference between the first and second images as a distance between the extracted features.

9. The method of claim 1, further comprising:
generating, at the generator in the GAN, at least one third image to represent a variation of the visual asset based on the first model.

10. The method of claim 9, wherein generating the at least one third image comprises generating the at least one third image based on at least one of a label associated with the visual asset or a digital representation of an outline of a portion of the visual asset.

11. The method of claim 9, wherein generating the at least one third image comprises generating the at least one third image by combining at least one portion of the visual asset with at least one portion of another visual asset.

12. (canceled)

13. A system comprising:
a memory configured to store first images captured from a three-dimensional (3D) digital representation of a visual asset; and
at least one processor configured to implement a generative adversarial network (GAN) comprising a generator and a discriminator,
the generator being configured to generate second images that represent variations of the visual asset with the discriminator attempting to distinguish between the first and second images, and
the at least one processor being configured to update at least one of a first model in the discriminator and a second model in the generator based on whether the discriminator successfully distinguished between the first and second images.

14. The system of claim 13, wherein the first images are captured using a virtual camera that captures the first images from different perspectives and under different lighting conditions.

15. The system of claim 14, wherein the memory is configured to store labels of the first images to indicate at least one of a type of the visual asset, a location of the virtual camera, a pose of the virtual camera, a lighting condition, a texture applied to the visual asset, and a color of the visual asset.

16. The system of claim 15, wherein the first images are segmented into portions associated with different portions of the visual asset, and wherein the portions of the first images are labeled to indicate the different portions of the visual asset.

17. The system of claim 13, wherein the generator is configured to generate the second images based on at least one of a hint or random noise.

18. The system of claim 13, wherein the at least one processor is configured to apply a loss function that indicates at least one of a first likelihood that the second images are not distinguishable from the first images by the discriminator or a second likelihood that the discriminator successfully distinguishes between the first and second images, and wherein the first model comprises a first distribution of parameters in the first images, and wherein the second model comprises a second distribution of parameters inferred by the generator.

19. (canceled)

20. The system of claim 18, wherein the loss function comprises a perceptual loss function that extracts features from the first and second images and encodes a difference between the first and second images as a distance between the extracted features.

21. The system of claim 13, wherein the generator is configured to generate at least one third image to represent a variation of the visual asset based on the first model.

22. The system of claim 21, wherein the generator is configured to generate the at least one third image based on at least one of a label associated with the visual asset or a digital representation of an outline of a portion of the visual asset.

23. The system of claim 21, wherein the generator is configured to generate the at least one third image by combining at least one segment of the visual asset with at least one segment of another visual asset.
